(19) United States
(12) Patent Application Publication
(10) Pub. No.: US 2015/0334162 A1
(43) Pub. Date: Nov. 19, 2015

(54) Navigation of Virtual Desktop Content on Devices

(71) Applicant: Citrix Systems, Inc., Fort Lauderdale, FL (US)

(72) Inventor: ShivaKumar Krishnamurthy, Fort Lauderdale, FL (US)

(73) Assignee: Citrix Systems, Inc., Fort Lauderdale, FL (US)

(21) Appl. No.: 14/276,724

(22) Filed: May 13, 2014

(51) Int. Cl. H04L 29/08

(52) U.S. Cl. CPC H04L 67/025; H04L 67/10

(57) ABSTRACT

Methods and systems for navigating virtual desktop content on client devices (e.g., mobile devices) are disclosed. Virtual desktop navigation may be responsive to physical movement of the client device, such that virtual desktop content is panned and/or zoomed based on the user physically moving the client device in 3D space. A client device launches a graphical user interface for a virtual desktop on a display. Display resolution is determined, and movement information is generated based on physical movement of the client device. The display resolution and movement information are sent to a server. The client device receives, from the server, a portion of the graphical user interface based on the display resolution, a resolution of the graphical user interface, and the movement information. The portion of the graphical user interface is presented on the display, such that the displayed portion appears to change responsive to the movement of the device.

### FIELD

Aspects described herein generally relate to computer virtualization and content navigation. In particular, one or more aspects of the disclosure are related to computer hardware and software for navigation of virtual desktop content on client devices.

### BACKGROUND

Mobile devices (e.g., smartphones, tablet computers, other types of mobile computing devices, etc.) are becoming increasingly popular in personal and business settings for a variety of purposes. Additionally, many people now have multiple computing devices, including one or more mobile devices, and these various devices may often be in different physical locations. For example, an example user may possess a work laptop computer that is typically located at home or in the user's office, as well as a mobile device that the user may take everywhere that he or she goes. A user may wish to be able to access electronic files, settings, and other information via the device that the user has in possession regardless of his or her location.

Many organizations are using desktop virtualization systems to provide more flexible options to address the varying needs of their users. In a desktop virtualization system, a user's computing environment (e.g., operating system, applications, and/or user settings) may be separated from the user's physical computing device (e.g., smartphone, laptop, desktop computer). By using client-server technology, a virtual desktop may be stored in and administered by a remote server, rather than in the local storage of the client device. A user may access the virtual desktop through a user interface on a client device; however, scrolling through and navigating content on the user interface may be difficult for the user due to the smaller display sizes of client devices, such as smartphones and tablets.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards providing approaches for content navigation of virtual applications and virtual desktops on client devices, and towards approaches that simplify content navigation of virtual applications and virtual desktops on client devices.

One or more aspects of the disclosure provide for a method that may include launching a virtual application on a client device, wherein the virtual application is accessible through a user interface shown on a display of the client device, and wherein the virtual application has an associated graphical user interface. The method may also include determining a display resolution of the client device; generating movement information based on detecting a physical movement of the client device in at least one of an x, y, and z axis; sending, to a server, the display resolution and the movement information; receiving, from the server, a portion of the graphical user interface based on the display resolution, a resolution of the graphical user interface, and the movement information; and displaying the portion of the graphical user interface on the display of the client device.

One or more aspects of the disclosure provide for a method that may include sending a graphical user interface for a virtual application to a client device for display by the client device; receiving, from the client device, a display resolution of the client device and movement information identifying a detected physical movement of the client device in at least one of an x, y, and z axis. The method may also include determining a portion of the graphical user interface to send the client device based on the display resolution, a resolution of the graphical user interface, and the movement information; and sending the portion of the graphical user interface to the client device.

One or more aspects of the disclosure provide for a system that includes at least one processor, and at least one memory storing instructions that, when executed by the at least one processor, cause the system to perform one or more steps. The steps the system may perform may include sending a graphical user interface for a virtual application to a client device for display by the client device; receiving, from the client device, a display resolution of the client device and movement information identifying a detected physical movement of the client device in at least one of an x, y, and z axis. The steps may also include determining a portion of the graphical user interface to send the client device based on the display resolution, a resolution of the graphical user interface, and the movement information; and sending the portion of the graphical user interface to the client device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative enterprise mobility management system.

FIG. 4 depicts another illustrative enterprise mobility management system.

FIG. 5 depicts an illustrative system of launching and navigating a virtual application or virtual desktop from a server on a client device in accordance with one or more features described herein.

FIGS. 6A-6B depict illustrative diagrams of examples of a graphical user interface on a display changing in response to movements of a client device in accordance with one or more features described herein.

FIG. 7 depicts an illustrative diagram of another example of a graphical user interface on a display changing in response to movements of a client device in accordance with one or more features described herein.

FIG. 8 depicts an illustrative flow diagram illustrating an example process of navigating virtual desktop content based on physical movements in a client device in accordance with one or more features described herein.

FIG. 9 depicts an illustrative flow diagram illustrating an example process of determining virtual desktop content to send to a client device from a server in accordance with one or more features described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards navigating content from a virtual application or virtual desktop on a client computing device. A user may access the virtual application or virtual desktop, provided by a server, through a user interface on the client device, wherein the virtual application or virtual desktop is associated with a graphical user interface. The client device may generate movement information that corresponds to a detected physical movement of the client device in at least one of an x, y, and z axis and send the movement information along with resolution information to the server. In this way, the server may determine a portion of the graphical user interface to send to the client device, and the client device may display the portion of the graphical user interface on a display that is accessible to the user. As a result, the user associated with the client device may advantageously utilize enterprise resources from a server and navigate virtual content on his or her personal client device (e.g., mobile device) by physical movements of the device.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

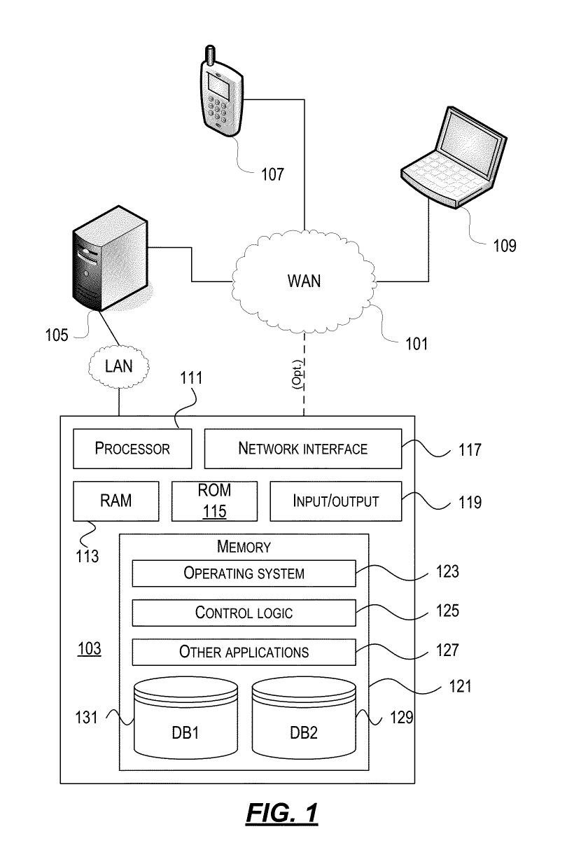

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, LANs, metropolitan area networks (MAN) wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the rate server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

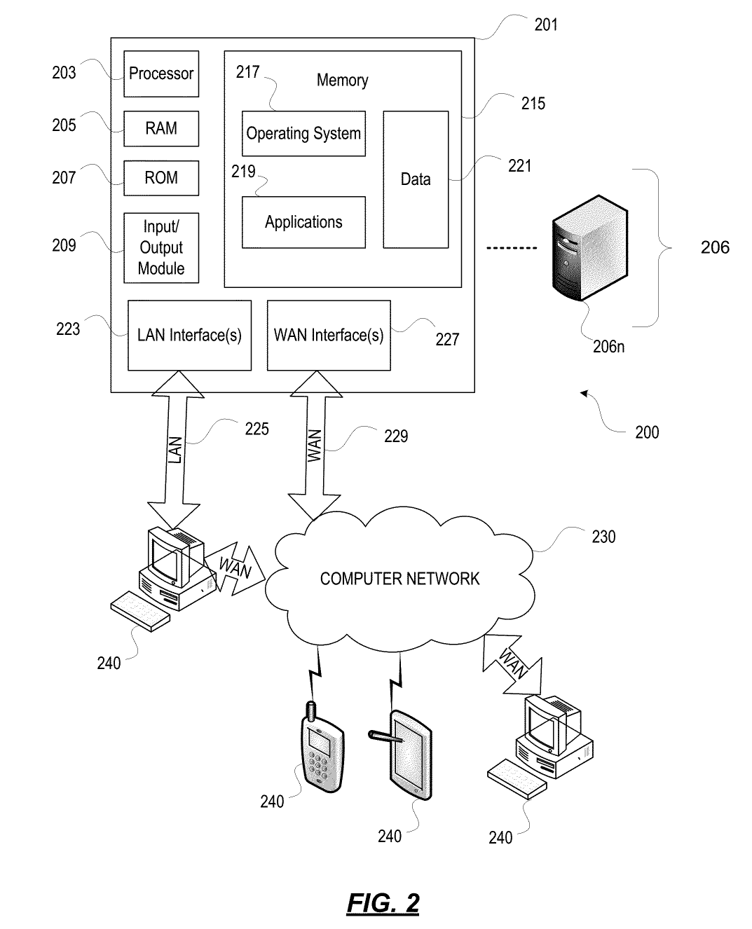

With further reference to FIG. 2, one or more aspects described herein may be implemented in a remote-access environment. FIG. 2 depicts an example system architecture including a generic computing device 201 in an illustrative computing environment 200 that may be used according to one or more illustrative aspects described herein. Generic computing device 201 may be used as a server 206a in a single-server or multi-server desktop virtualization system (e.g., a remote access or cloud system) configured to provide virtual machines for client access devices. The generic computing device 201 may have a processor 203 for controlling overall operation of the server and its associated components, including RAM 205, ROM 207, I/O module 209, and memory 215.

I/O module 209 may include a mouse, keypad, touch screen, scanner, optical reader, and/or stylus (or other input device(s)) through which a user of generic computing device 201 may provide input, and may also include one or more of a speaker for providing audio output and a video display device for providing textual, audiovisual, and/or graphical output. Software may be stored within memory 215 and/or other storage to provide instructions to processor 203 for configuring generic computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). The terminals 240 may be personal computers, mobile devices, laptop computers, tablets, or servers that include many or all of the elements described above with respect to the generic computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem 227 or other wide area network interface for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while and logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 106a that receives requests from a client machine 240, forwards the request to a second server 106b, and responds to the request generated by the client machine 240 with a response from the second server 106b. First server 106a may acquire an enumeration of applications available to the client machine 240 and well as address information associated with an application server 206 hosting an application identified within the enumeration of applications. First server 106a can then present a response to the client's request using a web interface, and communicate directly with the client 240 to provide the client 240 with access to an identified application. One or more clients 240 and/or one or more servers 206 may transmit data over network 230, e.g., network 101.

FIG. 2 shows a high-level architecture of an illustrative desktop virtualization system. As shown, the desktop virtualization system may be single-server or multi-server system, or cloud system, including at least one virtualization server 206 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

Enterprise Mobility Management Architecture

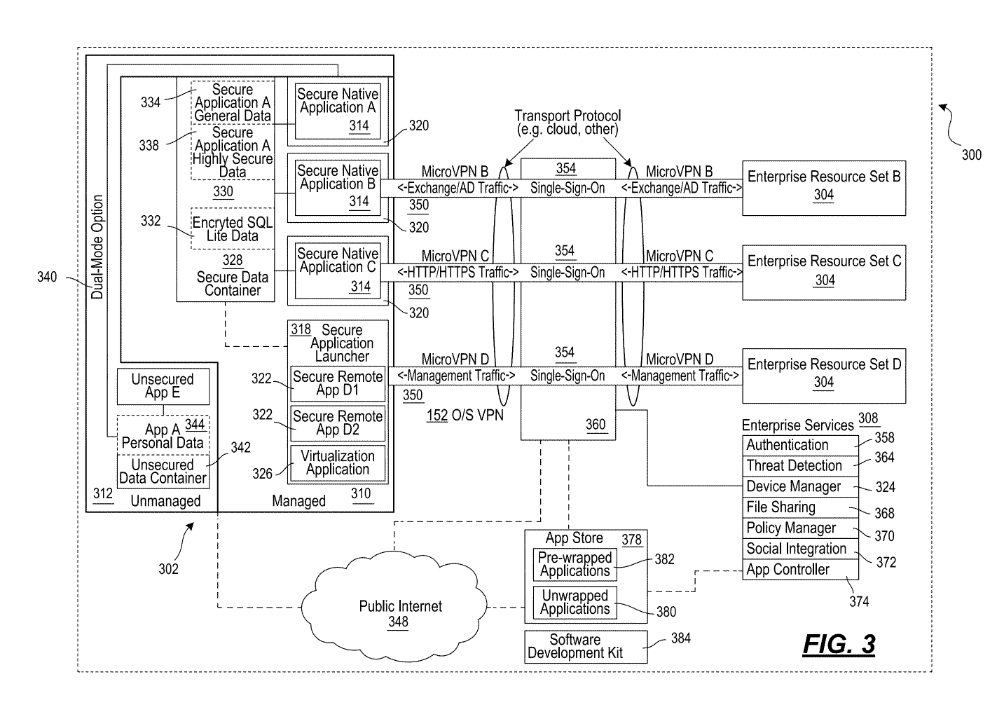

FIG. 3 represents an enterprise mobility technical architecture 300 for use in a BYOD environment. The architecture enables a user of a client device (e.g., mobile device) 302 to both access enterprise or personal resources from a mobile device 302 and use the mobile device 302 for personal use. The user may access such enterprise resources 304 or enterprise services 308 using a mobile device 302 that is purchased by the user or a mobile device 302 that is provided by the enterprise to user. The user may utilize the mobile device 302 for business use only or for business and personal use. The mobile device may run an iOS operating system, and Android operating system, or the like. The enterprise may choose to implement policies to manage the mobile device 302. The policies may be implanted through a firewall or gateway in such a way that the mobile device may be identified, secured or security verified, and provided selective or full access to the enterprise resources. The policies may be mobile device management policies, mobile application management policies, mobile data management policies, or some combination of mobile device, application, and data management policies. A mobile device 302 that is managed through the application of mobile device management policies may be referred to as an enrolled device.

In some embodiments, the operating system of the mobile device may be separated into a managed partition 310 and an unmanaged partition 312. The managed partition 310 may have policies applied to it to secure the applications running on and data stored in the managed partition. The applications running on the managed partition may be secure applications. In other embodiments, all applications may execute in accordance with a set of one or more policy files received separate from the application, and which define one or more security parameters, features, resource restrictions, and/or other access controls that are enforced by the mobile device management system when that application is executing on the device. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple apps as described herein (virtual partition). Stated differently, by enforcing policies on managed apps, those apps may be restricted to only be able to communicate with other managed apps and trusted enterprise resources, thereby creating a virtual partition that is impenetrable by unmanaged apps and devices.

The secure applications may be email applications, web browsing applications, software-as-a-service (SaaS) access applications, Windows Application access applications, and the like. The secure applications may be secure native applications 314, secure remote applications 322 executed by a secure application launcher 318, virtualization applications 326 executed by a secure application launcher 318, and the like. The secure native applications 314 may be wrapped by a secure application wrapper 320. The secure application wrapper 320 may include integrated policies that are executed on the mobile device 302 when the secure native application is executed on the device. The secure application wrapper 320 may include meta-data that points the secure native application 314 running on the mobile device 302 to the resources hosted at the enterprise that the secure native application 314 may require to complete the task requested upon execution of the secure native application 314. The secure remote applications 322 executed by a secure application launcher 318 may be executed within the secure application launcher application 318. The virtualization applications 326 executed by a secure application launcher 318 may utilize resources on the mobile device 302, at the enterprise resources 304, and the like. The resources used on the mobile device 302 by the virtualization applications 326 executed by a secure application launcher 318 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 304, and the like. The resources used at the enterprise resources 304 by the virtualization applications 326 executed by a secure application launcher 318 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application may record user interactions associated with a graphical user interface (GUI) and communicate them to a server application where the server application will use the user interaction data as an input to the application operating on the server. In this arrangement, an enterprise may elect to maintain the application on the server side as well as data, files, etc. associated with the application. While an enterprise may elect to “mobilize” some applications in accordance with the principles herein by securing them for deployment on the mobile device, this arrangement may also be elected for certain applications. For example, while some applications may be secured for use on the mobile device, others might not be prepared or appropriate for deployment on the mobile device so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device as well as a virtualization application to allow access to applications that are deemed more properly operated on the server side. In an embodiment, the virtualization application may store some data, files, etc. on the mobile phone in one of the secure storage locations. An enterprise, for example, may elect to allow certain information to be stored on the phone while not permitting other information.

In connection with the virtualization application, as described herein, the mobile device may have a virtualization application that is designed to present GUIs and then record user interactions with the GUI. The application may communicate the user interactions to the server side to be used by the server side application as user interactions with the application. In response, the application on the server side may transmit back to the mobile device a new GUI. For example, the new GUI may be a static page, a dynamic page, an animation, or the like, thereby providing access to remotely located resources.

The secure applications may access data stored in a secure data container 328 in the managed partition 310 of the mobile device. The data secured in the secure data container may be accessed by the secure wrapped applications 314, applications executed by a secure application launcher 322, virtualization applications 326 executed by a secure application launcher 322, and the like. The data stored in the secure data container 328 may include files, databases, and the like. The data stored in the secure data container 328 may include data restricted to a specific secure application 330, shared among secure applications 332, and the like. Data restricted to a secure application may include secure general data 334 and highly secure data 338. Secure general data may use a strong form of encryption such as Advanced Encryption Standard (AES) 128-bit encryption or the like, while highly secure data 338 may use a very strong form of encryption such as AES 256-bit encryption. Data stored in the secure data container 328 may be deleted from the device upon receipt of a command from the device manager 324. The secure applications may have a dual-mode option 340. The dual mode option 340 may present the user with an option to operate the secured application in an unsecured or unmanaged mode. In an unsecured or unmanaged mode, the secure applications may access data stored in an unsecured data container 342 on the unmanaged partition 312 of the mobile device 302. The data stored in an unsecured data container may be personal data 344. The data stored in an unsecured data container 342 may also be accessed by unsecured applications 548 that are running on the unmanaged partition 312 of the mobile device 302. The data stored in an unsecured data container 342 may remain on the mobile device 302 when the data stored in the secure data container 328 is deleted from the mobile device 302. An enterprise may want to delete from the mobile device selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device may connect to enterprise resources 304 and enterprise services 308 at an enterprise, to the public Internet 348, and the like. The mobile device may connect to enterprise resources 304 and enterprise services 308 through virtual private network connections. The virtual private network connections, also referred to as microVPN or application-specific VPN, may be specific to particular applications 350, particular devices, particular secured areas on the mobile device, and the like 352. For example, each of the wrapped applications in the secured area of the phone may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 354. The single-sign-on processes may allow a user to provide a single set of authentication credentials, which are then verified by an authentication service 358. The authentication service 358 may then grant to the user access to multiple enterprise resources 304, without requiring the user to provide authentication credentials to each individual enterprise resource 304.

The virtual private network connections may be established and managed by an access gateway 360. The access gateway 360 may include performance enhancement features that manage, accelerate, and improve the delivery of enterprise resources 304 to the mobile device 302. The access gateway may also re-route traffic from the mobile device 302 to the public Internet 348, enabling the mobile device 302 to access publicly available and unsecured applications that run on the public Internet 348. The mobile device may connect to the access gateway via a transport network 362. The transport network 362 may be a wired network, wireless network, cloud network, local area network, metropolitan area network, wide area network, public network, private network, and the like.

The enterprise resources 304 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 304 may be premise-based resources, cloud based resources, and the like. The enterprise resources 304 may be accessed by the mobile device 302 directly or through the access gateway 360. The enterprise resources 304 may be accessed by the mobile device 302 via a transport network 362. The transport network 362 may be a wired network, wireless network, cloud network, local area network, metropolitan area network, wide area network, public network, private network, and the like.

The enterprise services 308 may include authentication services 358, threat detection services 364, device manager services 324, file sharing services 368, policy manager services 370, social integration services 372, application controller services 374, and the like. Authentication services 358 may include user authentication services, device authentication services, application authentication services, data authentication services and the like. Authentication services 358 may use certificates. The certificates may be stored on the mobile device 302, by the enterprise resources 304, and the like. The certificates stored on the mobile device 302 may be stored in an encrypted location on the mobile device, the certificate may be temporarily stored on the mobile device 302 for use at the time of authentication, and the like. Threat detection services 364 may include intrusion detection services, unauthorized access attempt detection services, and the like. Unauthorized access attempt detection services may include unauthorized attempts to access devices, applications, data, and the like. Device management services 324 may include configuration, provisioning, security, support, monitoring, reporting, and decommissioning services. File sharing services 368 may include file management services, file storage services, file collaboration services, and the like. Policy manager services 370 may include device policy manager services, application policy manager services, data policy manager services, and the like. Social integration services 372 may include contact integration services, collaboration services, integration with social networks such as Facebook, Twitter, and LinkedIn, and the like. Application controller services 374 may include management services, provisioning services, deployment services, assignment services, revocation services, wrapping services, and the like.

The enterprise mobility technical architecture 300 may include an application store 378. The application store 378 may include unwrapped applications 380, pre-wrapped applications 382, and the like. Applications may be populated in the application store 378 from the application controller 374. The application store 378 may be accessed by the mobile device 302 through the access gateway 360, through the public Internet 348, or the like. The application store may be provided with an intuitive and easy to use User Interface.

A software development kit 384 may provide a user the capability to secure applications selected by the user by wrapping the application as described previously in this description. An application that has been wrapped using the software development kit 384 may then be made available to the mobile device 302 by populating it in the application store 378 using the application controller 374.

The enterprise mobility technical architecture 300 may include a management and analytics capability 388. The management and analytics capability 388 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

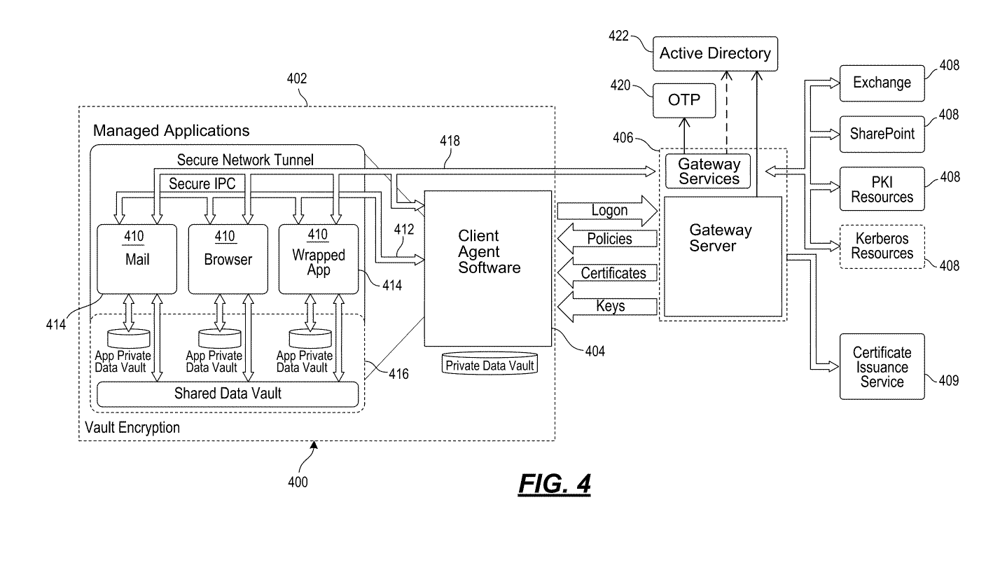

FIG. 4 is another illustrative enterprise mobility management system 400. Some of the components of the mobility management system 300 described above with reference to FIG. 3 have been omitted for the sake of simplicity. The architecture of the system 400 depicted in FIG. 4 is similar in many respects to the architecture of the system 400 described above with reference to FIG. 3 and may include additional features not mentioned above.

In this case, the left hand side represents an enrolled client device (e.g., mobile device) 402 with a client agent 404, which interacts with gateway server 406 (which includes Access Gateway and application controller functionality) to access various enterprise resources 408 and services 409 such as Exchange, Sharepoint, public-key infrastructure (PKI) Resources, Kerberos Resources, Certificate Issuance service, as shown on the right hand side above. Although not specifically shown, the mobile device 402 may also interact with an enterprise application store (StoreFront) for the selection and downloading of applications.

The client agent 404 acts as the UI (user interface) intermediary for Windows apps/desktops hosted in an Enterprise data center, which are accessed using the High-Definition User Experience (HDX)/ICA display remoting protocol. The client agent 404 also supports the installation and management of native applications on the mobile device 402, such as native iOS or Android applications. For example, the managed applications 410 (mail, browser, wrapped application) shown in the figure above are all native applications that execute locally on the device. Client agent 404 and application management framework of this architecture act to provide policy driven management capabilities and features such as connectivity and SSO (single sign on) to enterprise resources/services 408. The client agent 404 handles primary user authentication to the enterprise, normally to Access Gateway (AG) with SSO to other gateway server components. The client agent 404 obtains policies from gateway server 406 to control the behavior of the managed applications 410 on the mobile device 402.

The Secure interprocess communication (IPC) links 412 between the native applications 410 and client agent 404 represent a management channel, which allows client agent to supply policies to be enforced by the application management framework 414 “wrapping” each application. The IPC channel 412 also allows client agent 404 to supply credential and authentication information that enables connectivity and SSO to enterprise resources 408. Finally the IPC channel 412 allows the application management framework 414 to invoke user interface functions implemented by client agent 404, such as online and offline authentication.

Communications between the client agent 404 and gateway server 406 are essentially an extension of the management channel from the application management framework 414 wrapping each native managed application 410. The application management framework 414 requests policy information from client agent 404, which in turn requests it from gateway server 406. The application management framework 414 requests authentication, and client agent 404 logs into the gateway services part of gateway server 406 (also known as NetScaler Access Gateway). Client agent 404 may also call supporting services on gateway server 406, which may produce input material to derive encryption keys for the local data vaults 416, or provide client certificates which may enable direct authentication to PKI protected resources, as more fully explained below.

In more detail, the application management framework 414 “wraps” each managed application 410. This may be incorporated via an explicit build step, or via a post-build processing step. The application management framework 414 may “pair” with client agent 404 on first launch of an application 410 to initialize the Secure IPC channel and obtain the policy for that application. The application management framework 414 may enforce relevant portions of the policy that apply locally, such as the client agent login dependencies and some of the containment policies that restrict how local OS services may be used, or how they may interact with the application 410.

The application management framework 414 may use services provided by client agent 404 over the Secure IPC channel 412 to facilitate authentication and internal network access. Key management for the private and shared data vaults 416 (containers) may be also managed by appropriate interactions between the managed applications 410 and client agent 404. Vaults 416 may be available only after online authentication, or may be made available after offline authentication if allowed by policy. First use of vaults 416 may require online authentication, and offline access may be limited to at most the policy refresh period before online authentication is again required.

Network access to internal resources may occur directly from individual managed applications 410 through Access Gateway 406. The application management framework 414 is responsible for orchestrating the network access on behalf of each application 410. Client agent 404 may facilitate these network connections by providing suitable time limited secondary credentials obtained following online authentication. Multiple modes of network connection may be used, such as reverse web proxy connections and end-to-end VPN-style tunnels 418.

The Mail and Browser managed applications 410 have special status and may make use of facilities that might not be generally available to arbitrary wrapped applications. For example, the Mail application may use a special background network access mechanism that allows it to access Exchange over an extended period of time without requiring a full AG logon. The Browser application may use multiple private data vaults to segregate different kinds of data.

This architecture supports the incorporation of various other security features. For example, gateway server 406 (including its gateway services) in some cases will not need to validate active directory (AD) passwords. It can be left to the discretion of an enterprise whether an AD password is used as an authentication factor for some users in some situations. Different authentication methods may be used if a user is online or offline (i.e., connected or not connected to a network).

Step up authentication is a feature wherein gateway server 406 may identify managed native applications 410 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 416 (containers) on the mobile device 402. The vaults 416 may be encrypted so that all on-device data including files, databases, and configurations are protected. For on-line vaults, the keys may be stored on the server (gateway server 406), and for off-line vaults, a local copy of the keys may be protected by a user password or biometric validation. When data is stored locally on the device 402 in the secure container 416, it is preferred that a minimum of AES 256 encryption algorithm be utilized.

Other secure container features may also be implemented. For example, a logging feature may be included, wherein all security events happening inside an application 410 are logged and reported to the backend. Data wiping may be supported, such as if the application 410 detects tampering, associated encryption keys may be written over with random data, leaving no hint on the file system that user data was destroyed. Screenshot protection is another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the device is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key if the specific initialization vector used to encrypt the data is not known. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 414 may be prevented in other ways. For example, when an application 410 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature relates to the use of an OTP (one time password) 420 without the use of an AD (active directory) 422 password for access to one or more applications. In some cases, some users do not know (or are not permitted to know) their AD password, so these users may authenticate using an OTP 420 such as by using a hardware OTP system like SecurID (OTPs may be provided by different vendors also, such as Entrust or Gemalto). In some cases, after a user authenticates with a user ID, a text is sent to the user with an OTP 420. In some cases, this may be implemented only for online use, with a prompt being a single field.

An offline password may be implemented for offline authentication for those applications 410 for which offline use is permitted via enterprise policy. For example, an enterprise may want StoreFront to be accessed in this manner. In this case, the client agent 404 may require the user to set a custom offline password and the AD password is not used. Gateway server 406 may provide policies to control and enforce password standards with respect to the minimum length, character class composition, and age of passwords, such as described by the standard Windows Server password complexity requirements, although these requirements may be modified.

Another feature relates to the enablement of a client side certificate for certain applications 410 as secondary credentials (for the purpose of accessing PKI protected web resources via the application management framework micro VPN feature). For example, an application may utilize such a certificate. In this case, certificate-based authentication using ActiveSync protocol may be supported, wherein a certificate from the client agent 404 may be retrieved by gateway server 406 and used in a keychain. Each managed application may have one associated client certificate, identified by a label that is defined in gateway server 406.

Gateway server 406 may interact with an Enterprise special purpose web service to support the issuance of client certificates to allow relevant managed applications to authenticate to internal PKI protected resources.

The client agent 404 and the application management framework 414 may be enhanced to support obtaining and using client certificates for authentication to internal PKI protected network resources. More than one certificate may be supported, such as to match various levels of security and/or separation requirements. The certificates may be used by the Mail and Browser managed applications, and ultimately by arbitrary wrapped applications (provided those applications use web service style communication patterns where it is reasonable for the application management framework to mediate https requests).

Application management client certificate support on iOS may rely on importing a public-key cryptography standards (PKCS) 12 BLOB (Binary Large Object) into the iOS keychain in each managed application for each period of use. Application management framework client certificate support may use a HTTPS implementation with private in-memory key storage. The client certificate will never be present in the iOS keychain and will not be persisted except potentially in “online-only” data value that is strongly protected.

Mutual SSL may also be implemented to provide additional security by requiring that a mobile device 402 is authenticated to the enterprise, and vice versa. Virtual smart cards for authentication to gateway server 406 may also be implemented.

Both limited and full Kerberos support may be additional features. The full support feature relates to an ability to do full Kerberos login to Active Directory (AD) 422, using an AD password or trusted client certificate, and obtain Kerberos service tickets to respond to HTTP Negotiate authentication challenges. The limited support feature relates to constrained delegation in Citrix Access Gateway Enterprise Edition (AGEE), where AGEE supports invoking Kerberos protocol transition so it can obtain and use Kerberos service tickets (subject to constrained delegation) in response to HTTP Negotiate authentication challenges. This mechanism works in reverse web proxy (aka corporate virtual private network (CVPN)) mode, and when http (but not https) connections are proxied in VPN and MicroVPN mode.

Another feature relates to application container locking and wiping, which may automatically occur upon jail-break or rooting detections, and occur as a pushed command from administration console, and may include a remote wipe functionality even when an application 410 is not running.

A multi-site architecture or configuration of enterprise application store and an application controller may be supported that allows users to be serviced from one of several different locations in case of failure.

In some cases, managed applications 410 may be allowed to access a certificate and private key via an API (example OpenSSL). Trusted managed applications 410 of an enterprise may be allowed to perform specific Public Key operations with an application's client certificate and private key. Various use cases may be identified and treated accordingly, such as when an application behaves like a browser and no certificate access is required, when an application reads a certificate for “who am I,” when an application uses the certificate to build a secure session token, and when an application uses private keys for digital signing of important data (e.g. transaction log) or for temporary data encryption.

### Illustrative Embodiments

Having discussed several examples of the computing architecture and the enterprise mobility management architecture that may be used in providing and/or implementing various aspects of the disclosure, a number of embodiments will now be discussed in greater detail. In particular, and as introduced above, some aspects of the disclosure generally relate to navigating content of a graphical user interface associated with a virtual application or virtual desktop on a client device, such as on a smartphone or on a tablet. For example, a user may physically move the client device in at least one of an x, y, and z axis in order to navigate to content along the x, y, and z axis, respectively. The physical movement of the client device may correspond to generated movement information which a server may employ, along with resolution information, to determine which portion of the graphical user interface to send to the client device. In the discussion below, various examples illustrating movement-based navigation in accordance with one or more embodiments will be provided.

A client computing device may run remote desktop client software and hardware to access an application or desktop remotely. The remote desktop client software may display a graphical user interface for a virtual application or virtual desktop generated by an operating system and applications running on a server. The term “desktop” may refer to a virtual machine or physical system accessed by an end user at the client device as a local (to the user) desktop or workstation computer.

With recent trends in smaller form factors for client computing devices, navigating content in the graphical user interface may be difficult on client computing devices with smaller screens, such as on smartphones and tablets. By implementing features of the disclosure, a user may rely on physical movements of the client device instead of touch-based gestures to scroll and navigate content in the graphical user interface for the virtual application or virtual desktop. The disclosure may allow the user to scroll and navigate content from the virtual application or virtual desktop effortlessly with simple movements, wherein portions of the graphical user interface content may be provided by a server to the client device.

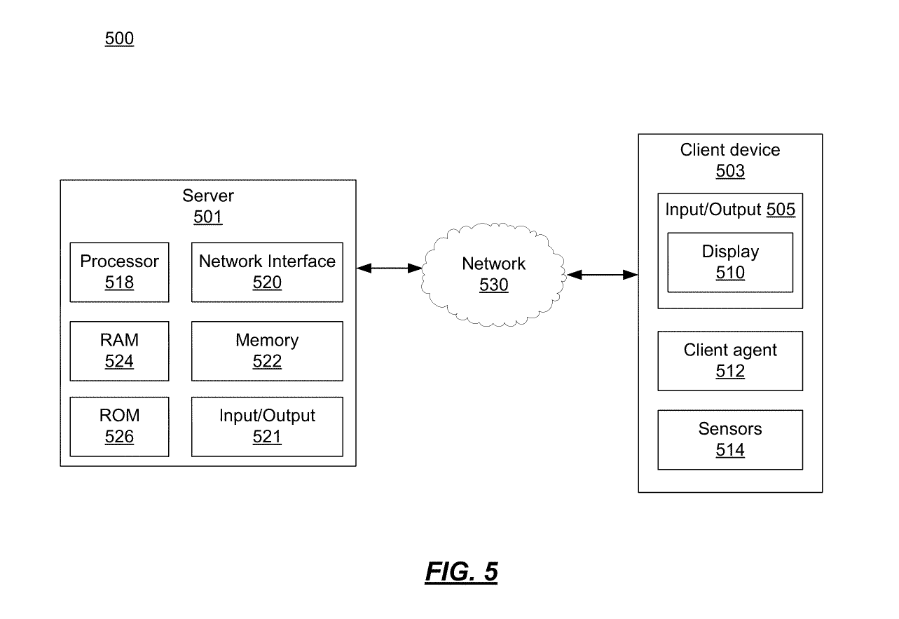

FIGS. 5-9 illustrate various examples of features, methods, and systems of virtual application or virtual desktop content navigation in client devices in accordance with one or more features described herein. The features and methods described below in reference to FIGS. 5-9 may be performed by a computing device or a combination of devices, such as the various computing devices and systems shown in FIGS. 1-5. The features, steps, and methods described below in reference to FIGS. 5-9 may be performed in any order, and one or more features, steps, or methods may be omitted and/or added. FIGS. 5-9 relate to navigating virtual application or virtual desktop content from a server on a client device. For example, an end user at terminal 240 or client device 302 or 402 may physically move the client device to generate movement information that is sent to a server 206, along with a display resolution of the client device. The user at the client device may receive, from the server 206, a portion of a graphical user interface associated with a virtual desktop based on the display resolution, a resolution of the graphical user interface, and the movement information.

In particular, FIG. 5 is an illustrative system 500 for launching and navigating a virtual application or virtual desktop from a server on a client device in accordance with one or more features described herein. The system 500 may include a server 501 connected to a client device 503 by a network 530. The server 501 and client device 503 may communicate via the network 530, which may be a wide area network (WAN) 101, such as the Internet. The network 530 may comprise one or more networks and may use one or more of a variety of different protocols, such as Ethernet. Server 501, client device 503, and other devices (not shown) may be connected to one or more of the networks via twisted pair wires, coaxial cable, fiber optics, radio waves or other communication media. It is understood that the system 500 may comprise any number of servers 501 and any number of client devices 503.

In an embodiment, the server 501 may be a virtualization server that provides virtual applications or desktops to the client device 503. For example, the server 501 may be the same as server 206, wherein the server 501 may be configured to provide virtual desktops and/or virtual applications to one or more client devices 503.

The server 501 may comprise a processor 518 that is in communication with network interface 520, input/output (I/O) devices 521, memory 522, random access memory (RAM) 524, and read only memory (ROM) 526. The processor 518 may be referred to as a central processor unit or CPU and may be implemented as one or more CPU chips. The processor 518 may be configured to perform or one or more steps of methods in accordance with one or more features described herein.

The network interface 520 may allow the server 501 to connect to and communicate with the network 530. Through the network 530, the server 501 may communicate with the client device 503 and other devices (not shown), such as laptops, notebooks, smartphones, tablets, personal computers, servers, etc.

The network interface 520 may connect to the network 530 via communication lines, such as coaxial cable, fiber optic cable, etc. or wirelessly using a cellular backhaul or a wireless standard, such as IEEE 802.11, IEEE 802.15, IEEE 802.16 etc., to name a few examples. In some embodiments, the network interface may include a modem. Further, the network interface 530 may use various protocols, including TCP/IP, Ethernet, File Transfer Protocol (FTP), Hypertext Transfer Protocol (HTTP), etc., to communicate with other client devices. The I/O devices 521 may include a variety of interface units and drivers for reading, writing, displaying, and/or printing data or files. For example, the I/O devices 521 may include a keyboard, mouse, display, printer, etc.

The memory 522 may be any computer readable medium for storing computer executable instructions (e.g., software). The instructions stored within memory 522 may enable the server 501 to perform various functions. For example, memory 522 may store software used by the server 501, such as one or more operating systems, application programs, and associated data (not shown) for the server 501. In an embodiment, memory 522 may store remote desktop software for providing virtual desktops and virtualization applications to the client device 503.

The server 501 may store computer-readable instructions in memory 522 in order to provide virtual desktops to the client device 503, as well as virtual application programs that execute after an instance of an operating system and virtual desktop has been loaded on the client device 503. In order for users to access the virtual desktops and virtual applications, the client device 503 may further comprise input/output (I/O) devices 505, a display 510, a client agent 512, and sensors 514.

The I/O devices 505 may include devices such as a microphone, keypad, keyboard, touchscreen, and/or stylus through which a user of the client device 503 may provide input data. The I/O devices 505 may also comprise a display 510, such as a monitor, television, touchscreen, etc. The display 510 may present a user interface of the client device 503 that is accessible to one or more users.

The client agent 512 may be used to access various enterprise resources through virtual desktops and applications provided by the server 501. For example, the client agent 512 may be the same as the client agent 404. The client agent 512 may launch a virtual desktop in the client device 503 after the server 501 has verified the identity and completed authentication of the user associated with the client device 503 as known to those of skill in the art. In an embodiment, the client agent 512 may be a CITRIX® RECEIVER™ brand client agent. A user may utilize the client agent 512 to access applications, desktops, and data through the HDX/ICA display remoting protocol, or through other remoting protocols.

The client agent 512 may also be employed to implement one or more features of the disclosure described herein. In an embodiment, the client agent 512 may allow portions of a graphical user interface for a virtual application or a virtual desktop to be delivered by the server 501 to the client device 503, wherein the portions of the graphical user interface are presented on the display 510 of the client device 503. The contents of the delivered portions of the graphical user interface may be based on movement information corresponding to physical movements of the client device 503 in at least one of an x, y, and z axis.

Physical movements of the client device 503 may be detected by the sensors 514. The sensors 514 may determine changes in position, velocity, and acceleration of the client device 503 in at least one of an x, y, and z axis. For example, the sensors 514 may comprise a gyroscope, which may be used to detect and measure angular velocity of the client device 503. The gyroscope may sense rotational motion of the client device 503 as well as changes in orientation of the client device 503. In an embodiment, the gyroscope may produce data measured in degrees per second (deg/s) or radians per second (rad/s).

The sensors 514 may also comprise an accelerometer, which may be used to detect and measure magnitude and direction of acceleration of the client device 503 in at least one of an x, y, and z axis. In some embodiments, acceleration in each of the x, y, and z dimensions are detected and measured. The accelerometer may measure g-force acceleration and may also be employed to determine the orientation of the client device 403. In an embodiment, the accelerometer may produce data measured in meters per second squared (m/s²) or g-forces (g), wherein g=9.81 m/s².

The gyroscope may be employed along with the accelerometer to measure directional movement of the client device 503 with respect to the lateral orientation or tilt during the directional movement. In another embodiment, the client device 512 may be a mobile device (e.g., mobile device 402) that comprises additional sensors 514, such as gravity sensors, rotational vector sensors, magnetometers, barometers, thermometers, etc.

The client device 503 may generate movement information based on the data received from the sensors 514. For example, the accelerometer may measure positive or negative g-force values in the x, y, and z axes. The data from the measurements may correspond to specific accelerations or movements of the client device 503 in the x, y, and z axes. For example, negative or positive values in the x axis may correspond to the client device 503 being moved to the left or right, respectively, in the x axis. Negative or positive values in the y axis may correspond to the client device 503 being moved down or up, respectively, in the y axis. Similarly, negative or positive values in the z axis may correspond to the client device 503 being moved backwards or forwards, respectively, the z axis. Upon detecting a physical movement of the client device 503, the client device 503 may generate movement information comprising the data received from the accelerometer, gyroscope, and/or other sensors 514.

In addition to the movement information, the client device 503 may determine a resolution of the display 510, wherein the size of the display 510 may affect the resolution. The display resolution may comprise a number of pixels in each dimension of the display of the client device 503. For example, the display resolution may be defined as the number of pixels in the width of the display by the number of pixels in the height of the display, or vice versa. In an embodiment, the display resolution of the client device 503 may be 1920×1080 pixels, 1024×768 pixels, 800×600 pixels, 640×480 pixels, or any other resolution based on the particular hardware in use.

Subsequently, the client device 503 may send the movement information and the display resolution to the server 501. In an embodiment, the movement information may be sent to the server 501 by the client agent 512 executing on the client device 503. The server 501 may then determine which portion of the graphical user interface to send to the client device 503. The physical movements of the client device 503 and the movement information sent to the server 501 may correspond to specific movements and navigation in the graphical user interface.

For example, if the movement information identifies physical movement of the client device 503 in the x axis, then the portion of the graphical user interface may be panned left or right based on the movement information. If the movement information identifies physical movement of the client device 503 in the y axis, then the portion of the graphical user interface may be panned up or down based on the movement information. If the movement information identifies physical movement of the client device 503 in the z axis, then the portion of the graphical user interface may be displayed at a zoom level based on the movement information.

By way of further example, a user associated with the client device 503 may move the client device 503 to the left/right or up/down to navigate to different sections of the graphical user interface for a virtual application or virtual desktop. Moreover, the user may move the client device 503 away from the user (e.g., backward acceleration in the z axis) to zoom out of the graphical user interface or towards the user (e.g., forward acceleration in the z axis) to zoom in to the graphical user interface.

The portion of the graphical user interface sent to the client device 503 may be determined based on the movement information, display resolution, and also a resolution of the graphical user interface. The resolution of the graphical user interface may comprise a number of pixels in each dimension of the graphical user interface for the virtual application. In an embodiment, the graphical user interface for the virtual application may have a resolution that is the same as or different than the display resolution of the client device 503.

Furthermore, the resolution of the graphical user interface for the virtual application may affect how much of the graphical user interface is navigated in response to physical movements of the client device 503. For example, a virtual application set to a lower resolution level comprises elements in the graphical user interface that are considerably larger than elements in a graphical user interface for a virtual application set to a higher resolution level. In this example, elements in the graphical user interface may comprise folders, icons, text, and other elements. A virtual application with a lower resolution level may necessitate a higher magnitude of movement (e.g., acceleration) for navigating (e.g., panning left/right, panning up/down, or zooming in/out) content in the graphical user interface than the magnitude of movement needed for navigating a virtual application with a higher resolution level. Therefore, it may be beneficial to use resolution for calibrating the extent of navigation in a virtual application or virtual desktop based on movements of the client device 503.

After determining which portion to send to the client device 503, the server 501 may scale the portion of the graphical user interface according to the display resolution of the client device 503. For example, the client device 503 may receive a scaled portion of the graphical user interface, wherein the graphical user interface may be presented, on the display 510, at a percentage of its original size/resolution. In yet another embodiment, the graphical user interface may be presented in its original resolution on the display 510, wherein the user may move the client device 503 along the z axis to zoom in and zoom out of content displayed on the graphical user interface.

In another feature of the disclosure, the server 501 may buffer additional portions of the graphical user interface to send to the client device 503 based on anticipated physical movements of the client device 503 in at least one of an x, y, and z axis. For example, a user may utilize the client device 503 to view an email inbox in the graphical user interface for the virtual application. In order to scroll through the list of emails, the user may physically move the client device 503 up and down the y axis to navigate to content not shown on the display 510. The movement in the y axis may be detected by the sensors 514, and movement information, along with display resolution, may be sent to the server 501 by the client agent 512. The server 501 may determine a portion of the graphical user interface to send to the client device 503 based on the detected movement information, display resolution of the client device 503, and the resolution of the graphical user interface. Moreover, the server 501 may buffer additional portions of the graphical user interface to send to the client device 503 in anticipation of any forthcoming movements in the y axis. For example, the server 501 may be able to determine that the user is moving the client device 503 along the y axis and may anticipate content that the user may wish to view if movements in the y axis continue. By anticipating physical movements of the client device 503, the server 501 may be able to optimize navigation of the graphical user interface for users in order to provide virtual application or virtual desktop content in a timely and efficient manner.

Furthermore, by sending just portions of the graphical user interface instead of the entire graphical user interface, the server 501 may be able to save bandwidth and reduce load in the network 130. Portions of the graphical user interface may comprise at least one of the following content: web services, web pages, applications, text, images, audio, and video. The type of content may affect how much of the content is sent by the server 501 to the client device 503 and how much processing is involved for displaying the content. For example, a user may view a web page on the graphical user interface for a virtual application or virtual desktop shown on the display 510 of the client device 503. The web page may comprise HTML, images, and video content. In order to scroll from side to side on the web page, the user may physically move the client device 503 left or right along the x axis.

The server 501 may receive movement information corresponding to measurements received from the sensors 514 (e.g., accelerometer, gyroscope) on the client device 503. The server 501 may then determine a portion of the graphical user interface to send to the client device 503, wherein the portion of the graphical user interface comprises video content. In an embodiment, the server 501 may compress the video content before sending the portion of the graphical user interface to the client device 503. The server 501 may also buffer additional portions comprising the compressed video content to send to the client device 503. Sending compressed video content may use less bandwidth of the network 530 than sending the video content without compression. In an embodiment, the client agent 512 in the client device 503 may receive the portion of the graphical user interface and decode and render the video before presenting the content in the display 510. Client-side rendering of the content of the graphical user interface portion may leverage the processing power of the client device 503 running the client agent 512, thereby offloading the server 501. In another embodiment, the server 501 may process the content of the portion of the graphical user interface at the server-side depending on the type of content. For example, if the content of the portion of the graphical user interface simply comprises a web browser or a HTML web page without video or other media content, then the processing may be conducted on the server 501, without necessitating any processing on the client device 503.

Additionally, visual input for generating movement information may also be employed by the client device 503. This may be advantageous when there are external factors that may contribute to the sensors 514 (e.g., accelerometer, gyroscope) falsely detecting physical movements of the client device 503. For example, a user may be a passenger in a moving vehicle when he or she wishes to access a virtual application or virtual desktop on his or her client device 503. If the client device 503 is stationary and mounted in a vehicle that is traveling at a constant velocity on a level road, the accelerometer might not measure any g-forces. However, the accelerometer may register positive or negative acceleration if the client device 503 is not mounted or if the vehicle is traveling at varying velocities on an uneven road. Therefore, in order to overcome falsely detected physical movements from the sensors 514, visual input obtained from a camera on the client device 503 may be useful to confirm whether or not a detected movement from the client device 503 is intentional.

In an embodiment, one of the sensors 514 of the client device 503 may comprise a camera which may provide images that may be utilized to generate movement information. A user may employ a front-facing camera on the client device 503 to take pictures of his or her surroundings. These pictures may be used to determine if the mobile device has moved with respect to the user's surroundings. That is, if the user is in a moving vehicle, any movement detected as a result of the vehicle's movement might not be used to adjust the display. Camera images might be used to detect whether the user remains fixed relative to the device's location, in which case the input might be ignored, or whether the user has moved relative to the device's location, in which case the input might be used to adjust the display area as described herein. For example, the user or device may initially take a reference picture with the front-facing camera to set a frame of reference for the client device 503 while accessing the virtual application or virtual desktop from a moving vehicle. In subsequent photos, if the user at least remains close to a fixed position relative to the device, motion might be determined to be a result of the moving vehicle, and therefore ignored.

In an embodiment, a picture may be taken by the front-facing camera at predetermined time intervals while the user accesses the virtual application or virtual desktop. For example, a picture may be taken every 1 second, 5 seconds, 30 seconds, 1 minute, or at another shorter or longer time interval. In another embodiment, a picture may be taken by the front-facing camera when a significant change in movement information is detected by the sensors 514 on the client device 503. For example, the accelerometer and gyroscope may generate data comprising measurements in the x, y, and z axes at certain time intervals. If the client device 503 receives data from the accelerometer and/or gyroscope that comprises a percentage of change above a certain threshold (with respect to previous measurements), then the front-facing camera may capture a picture and compare it to the reference picture to determine if a detected movement is an actual movement of the client device 503 from the user or an unintentional movement from external factors in an environment of the client device 503.

As another embodiment, the camera in the client device 503 may also detect one or more eye movements and/or head movements of the user in order to navigate virtual application or virtual desktop content in the graphical user interface. For example, the client agent 512 may send movement information comprising eye movement data and/or head movement data based on one or more eye movements and/or head movements detected by the front-facing camera on the client device 503. The server 501 may then send, to the client device 503, portions of the graphical user interface panning to the left, right, up, or down based on the directions of the detected movements.

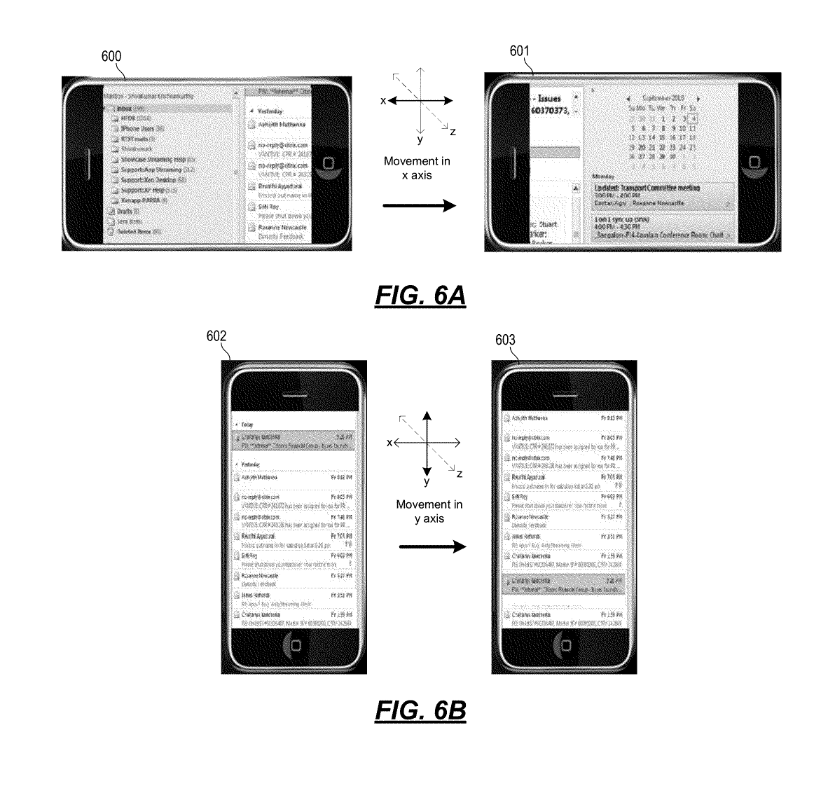

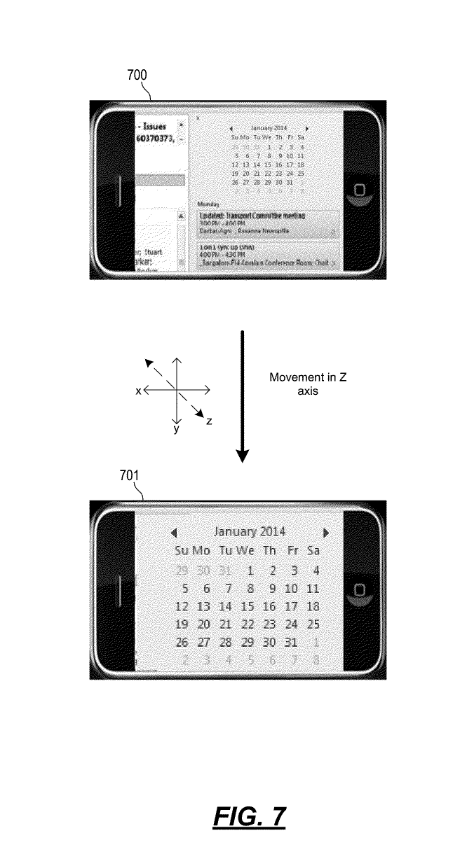

FIG. 6 and FIG. 7 illustrate examples of a graphical user interface on a display changing in response to movements of a client device in accordance with one or more features described herein. Specifically, FIG. 6A illustrates change in virtual content presented on displays 600-601 in response to movements of a client device in the x axis, whereas FIG. 6B illustrates change in virtual content presented on displays 602-603 in response to movements of a client device in the y axis. FIG. 7 illustrates changes in virtual content presented on displays 700-701 in response to movements of a client device in the z axis.

The displays 600-603 and 700-701 may be the same as the display 510, wherein the displays 600-603 and 700-701 each present a user interface of a client device that is accessible to one or more users. In an embodiment, the displays 600-603 and 700-701 may be touchscreens. The displays 600-603 and 700-701 may be associated with a client device, such as terminal 240, client device 302, enrolled mobile device 402, or client device 503. In another embodiment, the client device may be a smartphone, tablet, mobile device, phablet, laptop, etc.

As illustrated in FIGS. 6 and 7, users may navigate to different portions of a virtual application or virtual desktop by moving the client device in the direction to which the user wants to navigate. The displays 600-603 and 700-701 illustrate graphical user interfaces for an email application corresponding to a virtual desktop or virtual application launched in a client device. FIG. 6A illustrates multiple panes (e.g., an inbox pane, a preview pane, and a calendar pane) in the email application, whereas FIG. 6B illustrates a single inbox pane listing emails in the application. In FIG. 6A, when a user moves the client device to the right along the x axis, the client device may detect movement in the x axis by an accelerometer or gyroscope (e.g., sensors 514) and generate movement information corresponding to the detected movement. Similarly, in FIG. 6B, when a user moves the client device up along the y axis, the client device may detect movement in the y axis by an accelerometer or gyroscope (e.g., sensors 514) and generate movement information corresponding to the detected movement.

After sending this movement information and a resolution of the display (e.g., 600, 602) to a server, the client device may receive, from the server, a portion of the graphical user interface based on the display resolution, a resolution of the graphical user interface, and the movement information. After receiving the portion of the graphical user interface, the client device may display the content on the displays 601 and 603. The portion of the graphical user interface shown on the displays 601 and 603 may be different from the content that is presented on the displays 600 and 602, respectively prior to the user moving the client device. In FIG. 6A, the portion of the graphical user interface received by the client device may correspond to content from the right side of the email application, as illustrated in display 601. That is, the portion of the graphical user interface is panned to the right side, showing the calendar pane of the email application in display 601. In FIG. 6B, the portion of the graphical user interface received by the client device may correspond to a list of emails shown above the selected email in the inbox pane of the application, as illustrated in display 603. That is, the portion of the graphical user interface is panned down to show other emails in the inbox pane of the application in display 603.

Furthermore, in FIG. 7, a user may zoom in and zoom out of the graphical user interface by moving the client device towards the user and away from the user. Displays 700 and 701 illustrate a calendar pane in the graphical user interface for an email application corresponding to a virtual application or virtual desktop. When the user moves the client device towards the user in the z axis, the client device may detect movement in the z axis by an accelerometer or gyroscope (e.g., sensors 514) and generate movement information corresponding to the detected movement. After sending this movement information and a resolution of the display 700 to a server, the client device may receive, from the server, a portion of the graphical user interface based on the display resolution, a resolution of the graphical user interface, and the movement information and present the portion of the graphical user interface on the display 701. In FIG. 7, the portion of the graphical user interface received by the client device may correspond to a zoomed in view of the calendar pane presented on the display 701. The display resolution and the resolution of the graphical user interface may be utilized to display the portion of the graphical user interface at the appropriate zoom level.

In an embodiment, the portion of the graphical user interface may be presented at a zoom level determined by the server. For example, a user may wish to zoom in to a particular table or frame within the graphical user interface shown on the display 700. In an embodiment, the server may determine if there are any boundaries within a graphical user interface and may send a zoomed-in portion of the graphical user interface based on these boundaries. That is, the user might not be able to zoom in past a certain threshold (e.g., past a certain resolution) based on boundaries within the content received from the server. As an example, the user may move the client device to zoom in to the left side of the calendar shown in display 701 (e.g., zooming in to a specific day, such as Sunday, shown in the calendar). However, the portion shown on the screen may be toggled to show the calendar in full view, as the server may determine that there is a boundary to show the full calendar view. In other embodiments, the user may move the client device to zoom in to whichever portion of the calendar no matter the resolution boundaries within the content.

In another embodiment, the user may employ the client device in a landscape orientation as illustrated in FIG. 6A and FIG. 7 or in a portrait orientation as illustrated in FIG. 6B. The x, y, and z axes may be defined relative to the display of the client device in the orientation the user chooses. Although the virtual application or virtual desktop content illustrated in FIGS. 6 and 7 illustrate content from an email application, the virtual application or virtual desktop content may also comprise web services, web pages, applications, text, images, audio, and video. The movement information employed to navigate content may also comprise eye movement data and/or head movement data based on one or more eye movements and or/head movements detected by a camera on the client device.

In some embodiments, a user may lock and unlock virtual content navigation features on a client device. For example, after navigating (e.g., zooming in/out, panning left, right, up, or down) to a specific portion of the graphical user interface on his or her client device, the user may wish to continue viewing the portion of the graphical user interface without the content changing when the client device is physically moved. In other words, the user may wish to lock the display of the client device and prevent the portion of the graphical user interface presented on the display from changing with respect to user movements. The user may be able to lock and unlock features by sending a specific user input to the server (e.g., server 501). The user may press a volume button (up or down), press a key on the client device 503, click a button presented on the display 510 by the client agent 512 to lock, or provide another user input to lock and unlock virtual content navigation features. For example, the user may press a volume up button on the client device to unlock or activate movement-based navigation, and the user may press a volume down button on the client device to lock or deactivate movement-based navigation.

The client device may generate a lock message to send to the server upon receiving a user input for locking virtual content navigation. In an embodiment, the user may provide the user input to the client device in order for the client device to stop sending movement information to the server. In another embodiment, the lock message generated by the client device may indicate for the server to stop sending portions of the graphical user interface to the client device based on physical movements of the client device. The server may receive the lock message and discontinue sending portions of the graphical user interface to the client device. In order to unlock the movement-based navigation features, the client device may generate an unlock message to send to the server upon receiving another user input for unlocking. Upon receiving the unlock message, the server may continue to send, to the client device, additional portions of the graphical user interface based on physical movements of the client device in at least one of an x, y, or z axis.

As an additional feature, a user may remotely navigate content of virtual applications or virtual desktops in multiple client devices by movement. For example, the client agent (e.g., client agent 512) may be installed on multiple client devices, and a user may log onto the multiple client devices through the client agent. In an embodiment, the user may access a virtual application or virtual desktop through a first client device. The user may remotely navigate virtual content and access different portions of the virtual application or virtual desktop in the first client device by physically moving a second client device along at least one of an x, y, or z axis. In an embodiment, the second client device may be registered as a navigator or a navigating client device, wherein the second client device is designated to navigate content within the first client device. In some embodiments, the first client device may be a personal computer, laptop computer, or tablet, whereas the second client device may be a mobile device, smartphone, tablet, phablet, hand-held device, etc. In other embodiments, the first client device and the second client device may both comprise different mobile devices, smartphones, tablets, phablets, laptops, personal computers, etc.

The user may physically move the second client device along at least one of an x, y, or z axis, and movement information may be generated by the second client device based on the detected physical movement. The generated movement information may be sent to a server (e.g., server 501), along with a display resolution corresponding to a display (e.g., display 510) of the second client device. In an embodiment, the movement information may be represented by coordinates (x₂, y₂), generated based on values measured by an accelerometer, gyroscope, and/or other sensors (e.g., sensors 514) in the second client device. In another embodiment, the display resolution may comprise a total number of pixels in the x axis of the second client device and a total number of pixels in the y axis of the second client device. The server may receive the movement information and display resolution from the second client device. The server may also recognize that the second client device is registered as a navigating client device or navigator for accessing content within the first client device. Registration information regarding the second client device's navigator status may be sent to the server prior to sending the movement information and display resolution or at the same time that the movement information and display resolution are sent.

Upon receiving the movement information, display resolution, and registration information from the second client device, the server may employ a display resolution of the first client device to determine a portion of a graphical user interface associated with the first client device to send to the first client device. There may multiple ways for the server to access the display resolution of the first client device. In an embodiment, the server may access the display resolution of the first client device when the user initially signs on the first client device through the client agent. In another embodiment, the server may receive the display resolution of the first client device during a capability negotiation phase, which may be a phase or protocol that is implemented when the user requests access to the virtual desktop or virtual application. During the capability negotiation, the server may request information, such as the display resolution, from the first client device through the client agent.

Next, the server may determine the portion of the graphical user interface to send to the first client device by using the display resolution of the first client device to translate the (x₂, y₂) coordinates from the second client device into coordinates that correspond to the first client device. For example, the server may divide the value of the x coordinate (x₂) by the total number of pixels in the x axis of the second client device and multiply the result with a total number of pixels in the x axis of the first client device in order to compute a value of an x coordinate (x₁) of the first device. The server may then divide the value of the y coordinate (y₂) by the total number of pixels in the y axis of the second client device and multiply the result with a total number of pixels in the y axis of the first client device in order to compute a value of a y coordinate (y₁) of the first device. In an embodiment, the server may employ the following calculations to obtain coordinates (x₁, y₁) corresponding to the first client device:

$${X}_{1} = \frac{{X}_{2}}{\# of pixels in X axis of 2 nd device} \times total \# of pixels in X axis of 1 st device$$

$${Y}_{1} = \frac{{Y}_{2}}{\# of pixels in Y axis of 2 nd device} \times total \# of pixels in Y axis of 1 st device$$

After the server calculates the coordinates, the server may then send, to the first client device, the portion of the graphical user interface corresponding to the (x₁, y₁) coordinates. The first client device may present the portion of the graphical user interface on a display (e.g., display 510) of the first client device.

The server may also be able to translate movement or displacement along the z axis of the second client device into displacement along the z axis of the first client device in order to zoom in and/or zoom out of virtual content on the first client device. For example, after the second client device has been registered as the navigator or the navigating client device, the server may translate a value for z axis displacement of the second client device into a normalized value for z axis displacement of the first client device by multiplying the value by a mathematical ratio of the display areas for the first client device and the second client device. For example, the ratio may be defined as follows:

$$Ratio = \frac{( Display area of 1 st device )}{( Display area of 2 nd device )}$$

$$Ratio = \frac{( X axis length of 1 st device \times Y axis length of 1 st device )}{( X axis length of 2 nd device \times Y axis length of 2 nd device )}$$

The server may multiply the value for z axis displacement of the second client device by the ratio of the display areas. This calculation may result in a normalized value for the first client device, wherein the normalized value is a function of the display areas for both client devices. In an embodiment, the server may employ the following calculation to obtain the value of z₁, wherein z₁ represents displacement along the z axis for the first client device and z₂ represents displacement along the z axis for the second client device:

$${Z}_{1} = {Z}_{2} \times \frac{Display area of 1 st device}{Display area of 2 nd device}$$

The server may employ the normalized value for z axis displacement of the first client device to calibrate and/or determine a portion of the graphical user interface to present to the first client device. The first client device may then receive the portion from the server and present the zoomed in or zoomed out portion of the graphical user interface on the display (e.g., display 510).

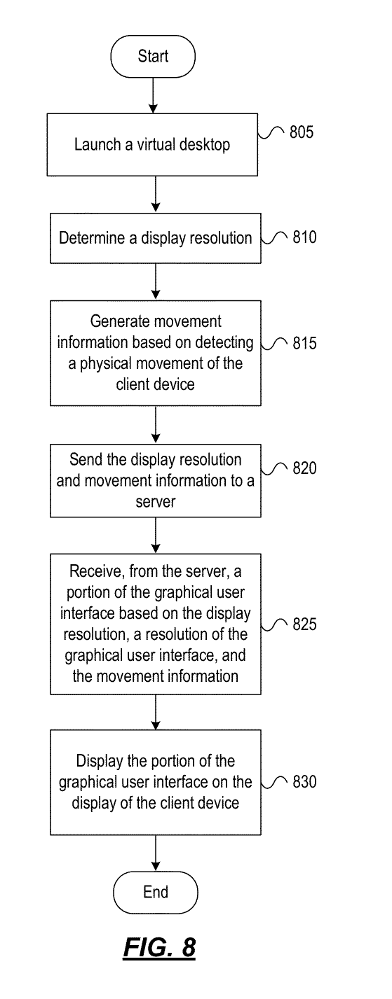

FIG. 8 is an illustrative flow diagram illustrating an example process of navigating virtual application or virtual desktop content based on physical movements in a client device. In one or more embodiments, the method illustrated in FIG. 8 and/or one or more steps thereof may be performed by a computing device (e.g., a client device such as terminal 240, client device 302, enrolled mobile device 402, or client device 503). In other embodiments, the process illustrated in FIG. 8 and/or one or more steps thereof may be embodied in computer-executable instructions that are stored in a computer-readable medium, such as a non-transitory computer-readable memory. Alternatively or additionally, any of the steps in the method of FIG. 8 may be performed on any client device.

As illustrated in FIG. 8, the method may begin at step 805 in which a client device may launch a virtual application or virtual desktop. In an embodiment, the client device 503 may launch a virtual desktop, wherein the virtual desktop may be provided by an application on the client device 503, such as by virtualization application 326 or client agent 512. The application may receive a virtual desktop and associated content from a server, such as virtualization server 206, gateway server 406, or server 501. The virtual application or virtual desktop may comprise an associated graphical user interface for an instance of an operating system in which local and/or remote applications may be integrated. The client device 503 may comprise a display, such as display 510, display 600, or display 700, that shows a user interface through which users may access the virtual application or virtual desktop. The client device 503 may employ the display 510 to present application output generated by an application remotely executing on the server 501 or on another remotely located machine.

At step 810, the client device may determine a display resolution. In an embodiment, the display resolution may comprise a number of pixels in each dimension of the display 510 of the client device 503. For example, the display resolution may be 1024×768 pixels, 800×600 pixels, or any other resolution. At step 815, the client device may generate movement information based on detecting a physical movement of the client device in at least one of an x, y, and z axis. In an embodiment, the client device 503 may generate movement information comprising data received from the sensors 514 on the client device 503, wherein the sensors 514 include an accelerometer and a gyroscope. The accelerometer and gyroscope may detect a physical movement of the client device 503 along the x, y, and/or z axis.

At step 820, the client device may send the display resolution and movement information to a server. In an embodiment, the client device 503 may send the resolution of the display 510 and movement information to the server 501. The movement information may comprise data received from the sensors 514, such as from an accelerometer or a gyroscope of the client device 503. In another embodiment, the movement information may also comprise eye movement data based on one or more user eye movements detected by a camera of the client device 503.

At step 825, the client device may receive, from the server, a portion of the graphical user interface based on the display resolution, a resolution of the graphical user interface, and the movement information. In an embodiment, the client device 503 may receive a portion of the graphical user interface from the server 501. The portion of the graphical user interface may be panned left/right or up/down based on a detected physical movement of the client device 503 in the x or y axis, respectively. Additionally, the portion of the graphical user interface may be displayed at a specific zoom level based on a detected physical movement of the client device 503 in the z axis. In an embodiment, the resolution information may affect how much of the graphical user interface is navigated in response to physical movements of the client device 503.

At step 830, the client device may display the portion of the graphical user interface on the display of the client device. In an embodiment, the client device 503 may present the portion of the graphical user interface on the display 510 of the client device 503. In an embodiment, the portion of the graphical user interface may be displayed on the client device 503 at a percentage of its original size/resolution. In another embodiment, the portion of the graphical user interface may be presented in its original resolution on the display 510, wherein the client device 503 may be physically moved along the z axis to zoom in and zoom out of content displayed on the graphical user interface.

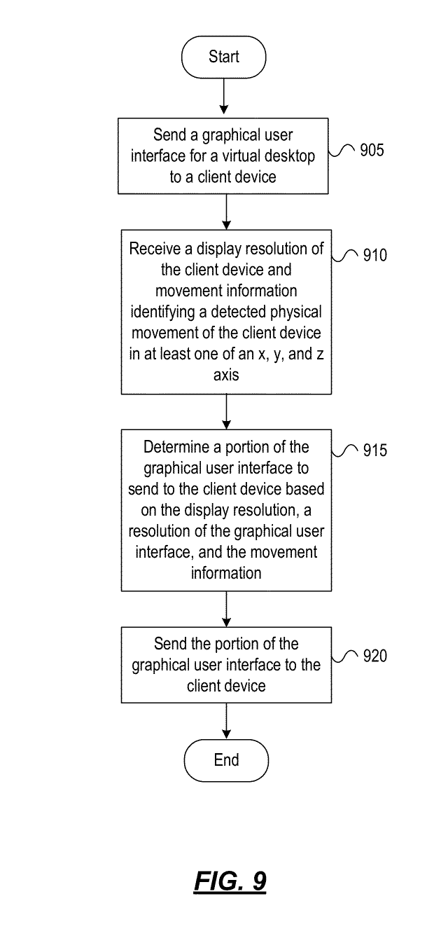

FIG. 9 depicts an illustrative flow diagram illustrating an example process of determining virtual application or virtual desktop content to send to a client device from a server in accordance with one or more features described herein. In one or more embodiments, the method illustrated in FIG. 9 and/or one or more steps thereof may be performed by a server (e.g., a server such as a server 206, enterprise resource servers 304, server 406, or server 501). In other embodiments, the process illustrated in FIG. 8 and/or one or more steps thereof may be embodied in computer-executable instructions that are stored in a computer-readable medium, such as a non-transitory computer-readable memory. Alternatively or additionally, any of the steps in the method of FIG. 9 may be performed on any server.

As illustrated in FIG. 9, the method may begin at 905 in which a server may send a graphical user interface for a virtual application or virtual desktop to a client device. In an embodiment, the server 501 may send a graphical user interface for a virtual application or virtual desktop to the client device 503, wherein the client device 503 may present the graphical user interface on the display 510. At step 910, the server may receive, from the client device, a display resolution of the client device and movement information identifying a detected physical movement of the client device in at least one of an x, y, and z axis. In an embodiment, the movement information received by the server 501 may comprise data from an accelerometer or a gyroscope of the client device 503. The movement information may correspond to a user physically moving the client device 503 in at least one of an x, y, and z axis.

At step 915, the server may determine a portion of the graphical user interface to send to the client device based on the display resolution, a resolution of the graphical user interface, and the movement information. In an embodiment, the server 501 may determine a portion of the graphical user interface to send to the client device 503 based on resolution information and movement information. The display size and resolution may influence which specific portion of the graphical user interface that the user is navigating to on the client device 503. The portion of the graphical user interface may comprise at least one of web services, web pages, applications, text, images, audio, and video. The server 501 may determine the type of content in the portion of the graphical user interface and may also compress the content before sending the portion to the client device 503.

At step 920, the server may send the portion of the graphical user interface to the client device. In an embodiment, the server 501 may send the portion of the graphical user interface to the client device 503. In another embodiment, the server 501 may send compressed content or a portion of graphical user interface that is scaled according to the display resolution of the client device 503.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method, comprising:
sending a graphical user interface for a virtual application to a client device for display by the client device;
receiving, from the client device, a display resolution of the client device and movement information identifying a detected physical movement of the client device in at least one of an x, y, and z axis;
determining a portion of the graphical user interface to send to the client device based on the display resolution, a resolution of the graphical user interface, and the movement information; and
sending the portion of the graphical user interface to the client device.

2. The method of claim 1, further comprising:
buffering additional portions of the graphical user interface to send to the client device based on anticipated physical movements of the client device in at least one of an x, y, and z axis.

3. The method of claim 2, wherein the movement information identifies anticipated movement in an x axis, and the additional portion of the graphical user interface is buffered along the x axis.

4. The method of claim 2, wherein the movement information identifies anticipated movement in a y axis, and the additional portion of the graphical user interface is buffered along the y axis.

5. The method of claim 2, wherein the movement information identifies anticipated movement in a z axis, and the additional portion of the graphical user interface is buffered along the z axis.

6. The method of claim 1, further comprising:
determining that the portion of the graphical user interface comprises video content;
compressing the video content to send to the client device; and
buffering additional portions of the graphical user interface to send to the client device based on anticipated physical movements of the client device in at least one of an x, y, and z axis.

7. The method of claim 1, further comprising:
upon determining the portion of the graphical user interface to send to the client device, scaling the portion of the graphical user interface according to the display resolution of the client device.

8. The method of claim 1, further comprising:
receiving, from the client device, a lock message indicating for the server to stop sending, to the client device, additional portions of the graphical user interface to the client device; and
stopping transmission of the additional portions of the graphical user interface to the client device.

9. A method, comprising:
launching a virtual application on a client device, wherein the virtual application is accessible through a user interface shown on a display of the client device, and wherein the virtual application has an associated graphical user interface;
determining a display resolution of the client device;
generating movement information based on detecting a physical movement of the client device in at least one of an x, y, and z axis;
sending, to a server, the display resolution and the movement information;
receiving, from the server, a portion of the graphical user interface based on the display resolution, a resolution of the graphical user interface, and the movement information; and
displaying the portion of the graphical user interface on the display of the client device.

10. The method of claim 9, further comprising:
generating a lock message based on a user input for the client device to stop sending movement information to the server; and
sending, to the server, the lock message indicating for the server to stop sending additional portions of the graphical user interface to the client device, wherein the client device does not receive additional portions of the graphical user interface from the server.

11. The method of claim 9, wherein the movement information comprises data received from at least one of an accelerometer or gyroscope of the client device.

12. The method of claim 9, wherein the movement information comprises eye movement data based on one or more user eye movements detected by a camera of the client device.

13. The method of claim 9, wherein the movement information identifies physical movement in an x or y axis, and the portion of the graphical user interface is panned left, right, up, or down based on the movement information.

14. The method of claim 9, wherein the movement information identifies physical movement in a z axis, and the portion of the graphical user interface is displayed at a zoom level based on the movement information.

15. The method of claim 9, wherein the movement information is sent to the server by a client agent executing on the client device.

16. A system comprising:
at least one processor; and
at least one memory storing computer-readable instructions that, when executed by the at least one processor, cause the system to:
send a graphical user interface for a virtual application to a client device for display by the client device;
receive, from the client device, a display resolution of the client device and movement information identifying a detected physical movement of the client device in at least one of an x, y, and z axis;
determine a portion of the graphical user interface to send to the client device based on the display resolution, a resolution of the graphical user interface, and the movement information; and
send the portion of the graphical user interface to the client device.

17. The system of claim 16, wherein the graphical user interface is a graphical environment or space providing the user interface for an instance of an operating system in which local applications and remote applications are integrated.

18. The system of claim 16, wherein the display resolution comprises a number of pixels in each dimension of the display of the client device.

19. The system of claim 16, wherein the portion of the graphical user interface comprises at least one of the following content: web services, web pages, applications, text, images, audio, and video.

20. The system of claim 16, wherein the portion of the graphical user interface is scaled according to the display resolution of the client device.
